(19) United States
(12) Patent Application Publication
(10) Pub. No.: US 2005/0173463 A1
(43) Pub. Date: Aug. 11, 2005

(54) Dispensing pump having linear and rotary actuators

(76) Inventor: John A. Wesner, Avon Lake, OH (US)

Correspondence Address: ROBERT W WELSH;EVEREADY BATTERY COMPANY INC, 25225 DETROIT ROAD, P O BOX 450777, WESTLAKE, OH, 44145, US

(21) Appl. No.: 11/053,498

(22) Filed: Feb. 8, 2005

Related U.S. Application Data
(60) Provisional application No. 60/543,077, filed on Feb. 9, 2004.

(51) Int. Cl. G01F 11/06; G01F 11/30; B67D 5/48; B67D 5/40; G01F 11/36; G01F 11/42; B65D 88/54

(52) U.S. Cl. 222/383.2

(57) ABSTRACT

A linear and rotary actuated liquid dispensing pump is provided which offers precise high speed dispensing of liquids and easy volume adjustability. The dispensing pump includes an inlet for receiving a supply of liquid, an outlet for dispensing a metered amount of liquid, and a cavity in communication with the inlet and outlet. The pump has a plunger disposed within a cavity for controlling the amount of liquid within the cavity. The pump also has a rotary actuator for rotating the plunger, and a linear actuator for actuating the plunger linearly within the cavity to control the fill and dispensing of liquid. A controller controls the linear and rotary actuators and allows operation input to adjust variables.

### CROSS-REFERENCE TO RELATED APPLICATIONS

This application claims the benefit of U.S. Provisional Application No. 60/543077, filed Feb. 09, 2004.

### BACKGROUND OF THE INVENTION

The present invention generally relates to pumps for dispensing a controlled quantity of liquid, and more particularly relates to a dispensing pump having a rotary and linear actuated pump/assembly for metering and dispensing a precise quantity of liquid.

Liquid dispensing pumps are commonly employed in various applications to precisely dispense a measured (metered) quantity of a liquid. In electrochemical cell (battery) manufacturing operations, liquid dispensing pumps are employed to dispense a metered quantity of liquid, such as alkaline electrolyte solution containing potassium hydroxide (KOH), into a battery can. In high speed battery manufacturing operations, the quantity of alkaline electrolyte solution dispensed within the battery can must be accurately and quickly dispensed in a fraction of a second.

Conventional liquid dispensing pumps typically employ an inlet receiving a supply of liquid, a pump assembly for pumping a metered quantity of the liquid, and an outlet nozzle through which the metered quantity of liquid is dispensed. The pump assembly generally includes a hollow cylinder in fluid communication with the inlet and outlet nozzle and a piston (plunger) disposed in the hollow cylinder. The plunger is actuated linearly to control the fill volume within a cavity in the cylinder into which a quantity of the liquid is drawn in and then evacuated.

Some conventional liquid dispensing pumps employ a single motor to drive the plunger linearly and also to rotate the plunger valving to control the flow of liquid drawn in at the inlet and dispensed via the outlet nozzle. One example of such a pump employs an electric stepper motor driving a pump housing having a plunger, a base supporting the pump module, and a displacement adjustment mechanism that is used to change the volume of liquid dispensed via the pump. The linear motion for the plunger stroke and rotary motion for the valving is achieved by using a complex compound joint/coupling. The displacement adjustment mechanism changes the pumping volume by changing the angle of the pump housing with respect to the motor. With the motor oriented at a horizontal angle with respect to the pump housing, the pump does not dispense any liquid. The volume dispensed with the pump increases with an increase in angle between the motor and pump housing from the horizontal position. With the pump housing rotated at an angle relative to the motor, a helix motion is created which causes the piston to stroke forward and backward and to rotate, simultaneously. Thus, a single motor is able to achieve both linear and rotary motion of the plunger.

The assembly employed in the aforementioned pump to effect the volume change generally causes fine adjustments to be time consuming and tedious because of the lack of precision in the adjustment mechanism. As a consequence, it is difficult to make fine volume adjustments to the pump. Additionally, adjustments of the pump to change the pumping volume are particularly difficult when the pump is mounted in confined areas where it is difficult to access the pump to adjust the displacement adjustment mechanism. The difficulties experienced with adjusting such a pump assembly can be time consuming which results in significant down time of the dispensing pump and any other associated equipment.

Accordingly, it is therefore desirable to provide for a liquid dispensing pump that provides for accurate control and easy adjustment of the metered amount of liquid to be dispensed. In particular, it is desirable to provide for a liquid dispensing pump that may be quickly adjusted to control the quantity of liquid dispensed in a high speed manufacturing operation.

### SUMMARY OF THE INVENTION

In accordance with the teachings of the present invention, a linear and rotary actuated pump is provided which offers precise high speed dispensing of liquids and easy adjustment of the pumping volume. The dispensing pump includes an inlet for receiving a supply of liquid, an outlet for dispensing a metered amount of liquid, and a cavity in communication with the inlet and outlet. The pump has a plunger disposed within a cavity for controlling the amount of liquid within the cavity. A rotary actuator is included for rotating the plunger. A linear actuator is included for actuating the plunger linearly within the cavity to control fill and dispensing of liquid.

According to one embodiment, the linear actuator is a linear servo motor, and the rotary actuator is a rotary servo motor, both of which are controlled by a controller. The liquid dispensing pump of the present invention advantageously can be easily adjusted to dispense a selected volume of liquid by electronically programming the controller. The rotary and linear actuation of the plunger can be independently adjusted, and may be adjusted on the fly, thereby avoiding significant down time.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a perspective view of a liquid dispensing pump employing linear and rotary actuators according to the present invention;

FIG. 2 is a perspective view of the pump in a refill position and illustrating the pump assembly in a partial cut-away view;

FIG. 3 is a perspective view of the pump in an intermediate discharge position and illustrating the pump assembly shown in cut-away view;

FIG. 4 is a perspective view of the pump in a full stroke position and illustrating the pump assembly in partial cut-away view;

FIG. 5 is a cross-sectional view of the pump assembly taken through lines V-V of FIG. 2;

FIG. 6 is a cross-sectional view of the pump assembly taken through lines VI-VI of FIG. 3;

FIG. 7 is a cross-sectional view of the pump assembly taken through lines VII-VII of FIG. 4; and

FIG. 8 is a cam table diagram illustrating control of the rotary and linear actuation of the pump assembly.

### DETAILED DESCRIPTION OF THE PREFERRED EMBODIMENT

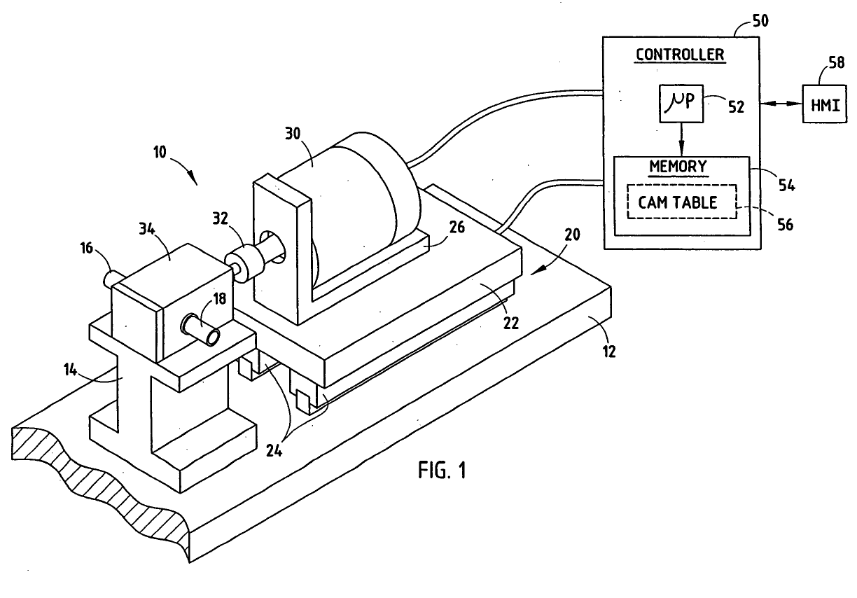

Referring to FIGS. 1-4, a linear and rotary actuated liquid dispensing pump 10 is generally illustrated for cyclically (repeatedly) dispensing a precisely controlled quantity of liquid. The dispensing pump 10 includes an underlying base platform 12 supporting the general assembly of the pump 10. Supported on platform 12 is an I-beam support member 14 which further supports a pump control assembly 34. Dispensing pump 10 includes an inlet 16 for receiving a supply of liquid, and an outlet nozzle 18 for dispensing the controlled quantity of liquid. The pump control assembly 34 is disposed between the inlet 16 and the outlet nozzle 18.

The supply of liquid may include a substantially continuous supply of liquid that is to be repeatedly dispensed in periodic cycles in a controlled quantity via the dispensing pump 10. The supply of liquid may include any of a variety of liquids having differing viscosities. In an alkaline battery manufacturing system, the liquid may include a low viscosity alkaline electrolyte solution containing potassium hydroxide (KOH). Alternately, the supply of liquid dispensed in a battery manufacturing system may include a higher viscosity liquid, such as anode gel. The dispensing pump 10 may be employed to dispense any of a variety of liquids.

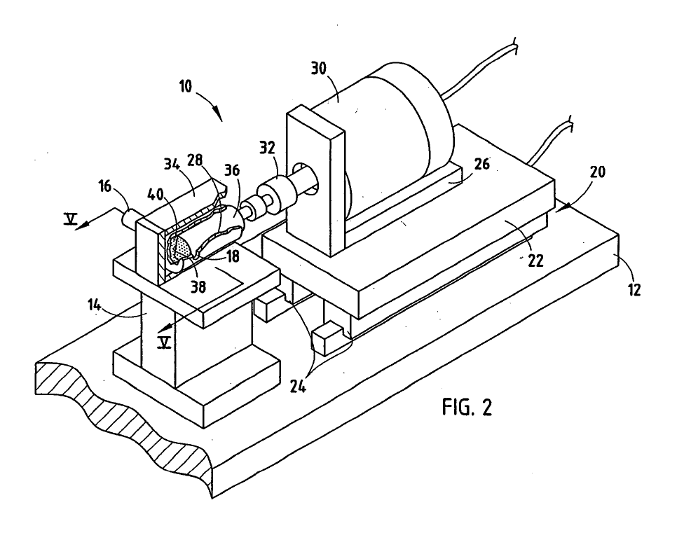

As seen in FIGS. 2-7, the pump control assembly 34 includes a plunger (piston) 36 of a generally cylindrical cross-section disposed within a hollow cylinder 28. The hollow cylinder 28 has a closed end and defines a cavity substantially closed at one end by the plunger 36 and exposed to inlet 16 and outlet nozzle 18. The plunger 36 is both rotated and moved linearly within cylinder 28. The plunger 36 has a passageway 38 formed therein which provides a liquid fill volume and provide a liquid flow path between one of the inlet 16 and outlet nozzle 18, depending on the rotational and linear position of the plunger 36. The passageway 38 defines a full volume for receiving liquid 40 from the inlet 16 when the plunger 36 is in the refill position. When the plunger 36 is in a dispense position, the passageway 38 is in fluid communication with outlet nozzle 18 to allow the metered quantity of liquid 40 to be dispensed through outlet nozzle 18.

The liquid dispensing pump 10 employs a rotary actuator 30 in the form of a rotary servo motor, and also employs a linear actuator 20 in the form of a linear servo motor, according to the embodiment shown and described herein. The linear servo motor 20 is disposed on top of the base platform 12. The rotary servo motor 30 is mounted on an L-shaped motor support member 26 on top of the linear servo motor 20. Accordingly, linear actuation of the linear servo motor 20 likewise causes linear actuation of the rotary servo motor 30.

The rotary servo motor 30 has an output shaft 32 connected to the plunger 36. Accordingly, rotation of the rotary servo motor 30 causes rotation of plunger 36 within cylinder 28. In the embodiment shown and described herein, the rotary servo motor 20 continuously rotates plunger 36 at a substantially constant angular speed. However, speed of the rotary motor 30 may be controlled to vary the speed or turn off the motor 30. The rotary servo motor 30 and/or its output shaft 32 may include an angular position sensor, such as an encoder, for monitoring the angular position of the output shaft 32. Additionally, a linear position sensor may be employed to monitor the linear positioning of the output shaft 32 and corresponding plunger 36.

The rotary servo motor 30 may include a 60 mm frame brushless rotary servo motor employing a digital servo driver, such as a ServoStar CD Sercos Digital Servo Drive, commercially available from Kollmorgen. It should be appreciated that any of a number of rotary motors, both AC and DC, may be employed to rotate the plunger 36.

The linear servo motor 20 is shown as a continuous iron-core linear servo motor having a linearly actuated platform 22 mounted over a pair of magnets 24. Platform 22 is forcibly actuated relative to magnets 24 to cause linear actuation of platform 22. The linear servo motor 20 further includes a digital servo drive, such as a Servo Star CD Sercos Digital Servo Drive, commercially available from Kollmorgen. It should be appreciated that the linear motor 20 may be precisely adjusted to achieve a desired linear movement, according to an electronic cam table as described herein.

Referring back to FIG. 1, the liquid dispensing pump 10 further includes a controller 50 for controlling actuation of the rotary servo motor 30 and linear servo motor 20. The controller 50 may include a multi-axis motion controller. In the embodiment shown, the controller 50 has a microprocessor 52 and memory 54 capable of processing algorithms and data to control the rotary and linear servo motors 30 and 20, respectively. The microprocessor 52 has sufficient capabilities to process algorithms and data as described herein. The memory 54 may include read-only memory (ROM), random access memory (RAM), flash memory, and other commercially available volatile and non-volatile memory devices. One example of a commercially available controller may include the ServoStar MC multi-axis motion controller, commercially available from Kollmorgen. Stored within memory 54 is an electronic cam table 56 for controlling the operation of the rotary and linear servo motors 30 and 20, respectively, to effect rotating and linear motion of plunger 36 as shown in FIG. 8 and described herein.

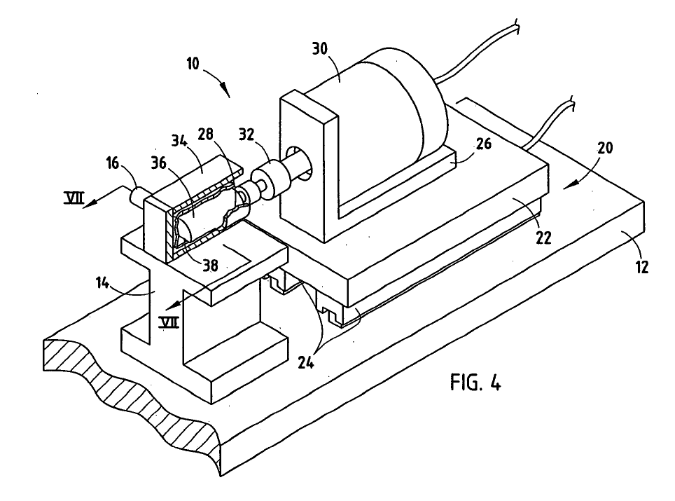

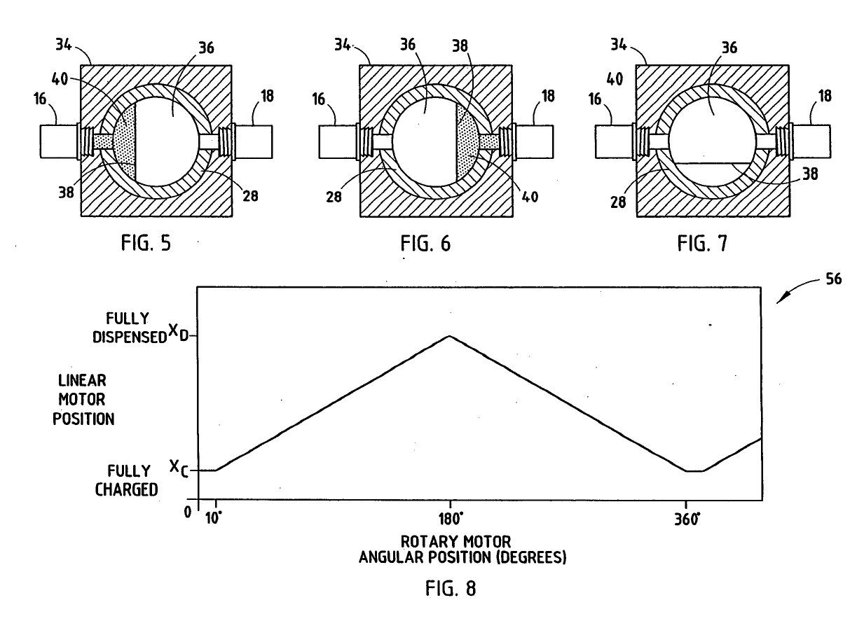

The liquid dispensing pump 10 is operated such that the rotary servo motor 30 cyclically rotates plunger 36 into various positions through each complete 360 degrees of rotation, while linear servo motor 20 moves the plunger 36 forward and backward to cause liquid received in the inlet 16 to be drawn in during the refill motion, and discharged through outlet nozzle 18 during the discharge motion. In doing so, the plunger 36 is oriented within the passageway 38 in liquid communication with inlet 16 as shown in FIGS. 2 and 5 when the plunger 36 is in a refill position. In this position, liquid is allowed to enter through inlet 16 into the fill volume between the plunger 36 and interior of hollow cylinder 38. During the refill motion, the linear servo motor actuator 20 retracts the plunger 36 from within cylinder 28 so as to draw a quantity of liquid into the fill volume defined between the plunger 36 and inner walls of cylinder 28.

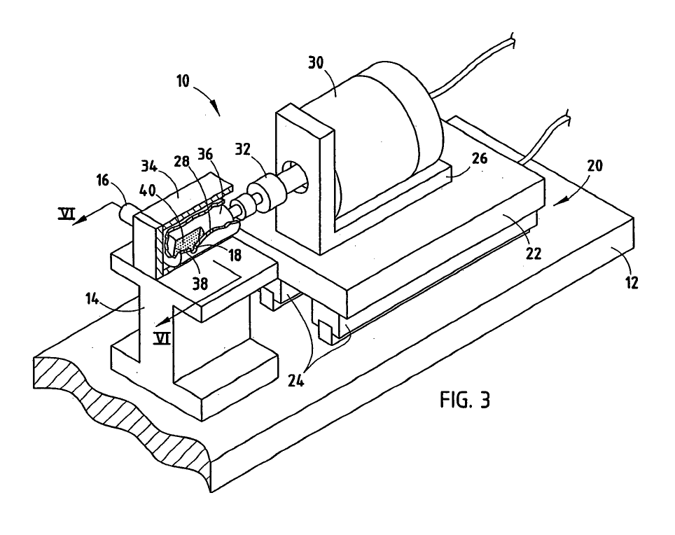

With the pump completely refilled at the rearmost position of plunger 36, the linear actuator 20 reverses direction to force the liquid contained within the fill volume between plunger 36 and cylinder 38 out through outlet nozzle 18 once the plunger 36 is sufficiently rotated so that the liquid in the fill volume is in liquid communication with outlet nozzle 18, as shown in FIGS. 3 and 6. In this position, the metered quantity of liquid is dispensed through the outlet nozzle 18 as shown.

Following the dispensing of liquid through outlet nozzle 18, the linear servo motor 20 and plunger 36 continue to rotate to the point where the plunger 36 reaches the full stroke position as shown in FIGS. 4 and 7. In this position, the outlet nozzle 18 is no longer in fluid communication with the fill volume and the pump 10 is ready to repeat the cycle of refilling and discharging liquid in a precise quantity.

The controller 50 is able to control actuation of the rotary servo motor 30 and linear servo motor 20 according to a cam table 56 which is further illustrated in FIG. 8. As shown in the cam table 56, the rotary servo motor 30 repeatedly rotates through a complete revolution of 0° to 360°. During one complete revolution of plunger 36, the linear servo motor 30 is controlled by controller 50 as shown. From 0° to 10° of rotation of the rotary servo motor 30, the linear servo motor 20 remains in a dwell position of no movement. From 10° to 180° of rotation of the rotary servo motor 30, the linear servo motor 20 moves from its fully charged position to the fully displaced position which dispenses the liquid. With the rotary servo motor 30 at 180°, the linear servo motor 20 reverses direction and retracts itself to its fully recharged position X_{C} at which time the rotary servo motor 30 is at 360°. The cam table 56 is then repeatedly processed by controller 50 to provide the next fill and dispensing cycles.

It should be appreciated that the position of the linear servo motor 20 may be adjusted by simply entering in a new fully charged position X_{C} into controller 50 via the human machine interface (HMI) 58, which may include a personal computer, according to one embodiment. Thus, in order to change the amount of liquid dispensed with pump 10, a new fully charged position X_{C} is simply entered via HMI 58 into the controller 50. Additionally, the linear servo motor 20 may likewise be adjusted electronically, by inputting into controller 50 via HMI 58 a servo linear motor speed value. Additionally, linear servo motor 20 can be controlled to provide a periodic dwell (off) state.

While a linear servo motor 20 is shown and described herein for linearly moving the plunger 36 in connection with dispensing pump 10, it should be appreciated that other linear and rotary actuators may be employed. For example, a rotary motor coupled to a rotary-to-linear converter (e.g., roller screw and sliding nut assembly) may be employed in place of the linear servo motor 20 to linearly actuate plunger 36. Similarly, an alternative actuator may be employed in place of the rotary servo motor 30.

The dispensing pump 10 of the present invention is able to precisely meter and dispense a quantity of liquid to provide enhanced liquid dispensing operation. The dispensing pump is easily adjustable to set the quantity of liquid to dispense, which is particularly useful in high speed manufacturing systems. For example, the dispensing pump 10 may be employed in a high speed battery manufacturing system such as disclosed in U.S. Pat. No. 6,325,198, entitled “HIGH SPEED MANUFACTURING SYSTEM.” The dispensing pump 10 may easily be adjusted to set new setpoints for each of the rotary and linear actuators 30 and 20, respectively, as described herein.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A dispensing pump for dispensing liquid comprising:
an inlet for receiving a supply of liquid;
an outlet for dispensing a metered amount of liquid;
a cavity in communication with the inlet and outlet;
a plunger disposed within a cavity for controlling the amount of liquid within the cavity;
a rotary actuator for rotating the plunger; and
a linear actuator for actuating the plunger linearly within the cavity to control fill and dispensing of liquid.

2. The pump as defined in claim 1 further comprising a controller for controlling actuation of the linear actuator.

3. The pump as defined in claim 2, wherein the linear actuator is controlled as a function of an electronic cam table.

4. The pump as defined in claim 1, wherein the rotary actuator is connected on the linear actuator, such that linear actuation of the linear actuator causes linear actuation of the rotary actuator.

5. The pump as defined in claim 1, wherein the linear actuator comprises a linear servo motor.

6. The pump as defined in claim 5, wherein the rotary actuator comprises a rotary servo motor supported on the linear servo motor.

7. The pump as defined in claim 1, wherein the pump is employed to pump liquid into a container in a high speed manufacturing system.

8. The pump as defined in claim 7, wherein the high speed manufacturing system is a battery manufacturing system.

9. A method of dispensing liquid between an inlet and an outlet, comprising the steps of:
receiving a supply of liquid in an inlet;
rotating a plunger within a cavity into a position to receive liquid from the inlet;
linearly actuating the plunger to draw in liquid into the cavity;
rotating the plunger into a position to dispense liquid to an outlet; and
linearly actuating the plunger to dispense the liquid from the cavity to the outlet.

10. The method as defined in claim 9, wherein the steps of linearly actuating the plunger are controlled by a controller as a function of an electronic cam table.

11. The method as defined in claim 10, wherein said step of linearly actuating the plunger likewise linearly actuates a rotary actuator for rotating the plunger.

12. The method as defined in claim 9, wherein the step of linear actuation comprises retracting the plunger to draw in liquid from the inlet and extending the plunger to dispense the liquid to the outlet.

13. The method as defined in claim 9, wherein the method is performed in a high speed manufacturing system.

14. The method as defined in claim 13, wherein the high speed manufacturing system is a battery manufacturing system.
